(19) United States
(12) Patent Application Publication
(10) Pub. No.: US 2026/0086822 A1
(43) Pub. Date: Mar. 26, 2026

(54) FUNCTION CONFIGURATION METHOD, TASK HANDLING METHOD, DEVICE, AND MEDIUM

(71) Applicant: Beijing Youzhuju Network Technology Co., Ltd., Beijing (CN)

(72) Inventors: Lei HONG, Beijing (CN); Jiyuan TANG, Beijing (CN); Pengfei JIANG, Beijing (CN)

(21) Appl. No.: 19/342,193

(22) Filed: Sep. 26, 2025

(30) Foreign Application Priority Data
Sep. 26, 2024 (CN) 202411356473.5

(51) Int. Cl. G06F 9/445; G06F 9/48

(52) U.S. Cl. CPC G06F 9/44505; G06F 9/4806

(57) ABSTRACT

The present disclosure relates to the technical field of computers and discloses a function configuration method, a task handling method, a device, and a medium. The function configuration method includes: obtaining a configuration instruction, in which the configuration instruction is used for instantiating a task node in a target workflow to obtain a target node instance, the target workflow is used for implementing a target function; constructing a first workflow instance of the target workflow based on the target node instance; and adding the first workflow instance to a tool list, in which the tool list is used for characterizing a workflow instance corresponding to a function of a target agent, and the target agent is constructed based on the tool list. The present disclosure can solve the problem of complex expansion of the functions of an agent.

### CROSS-REFERENCE TO RELATED APPLICATION

This application claims priority to Chinese Patent Application No. 202411356473.5 filed on Sep. 26, 2024, the disclosure of which is incorporated herein by reference in its entirety as part of this application.

### TECHNICAL FIELD

The present disclosure relates to the technical field of computers, and in particular, to a function configuration method, a task handling method, an apparatus, a device, a medium, and a product.

### BACKGROUND

An agent refers to an intelligent agent that can perceive the environment and take actions to achieve a goal. An agent based on a large language model (abbreviated as LLM) can use tools to interact with the outside world. In related technologies, a large number of preset tools are provided for the agent to implement different functions. However, each of the tools can only implement a specific function, and when a new function is to be implemented, a tool must be modified or a new tool must be built, resulting in complex expansion of the functions of the agent.

### SUMMARY

In view of this, the present disclosure provides a function configuration method, a task handling method, an apparatus, a device, a medium, and a product to solve the problem of complex expansion of the functions of the agent.

In a first aspect, the present disclosure provides a function configuration method, the method includes:
obtaining a configuration instruction, in which the configuration instruction is used for instantiating a task node in a target workflow to obtain a target node instance, and the target workflow is used for implementing a target function;
constructing a first workflow instance of the target workflow based on the target node instance; and
adding the first workflow instance to a tool list, in which the tool list is used for characterizing a workflow instance corresponding to a function of a target agent, the target agent is constructed based on the tool list.

In a second aspect, the present disclosure provides a task handling method, the method includes:
obtaining a target function corresponding to a target task;
determining a first workflow instance in a tool list based on the target function, in which the tool list is used for characterizing a workflow instance corresponding to a function of a target agent; the first workflow instance is constructed by instantiating a task node in a target workflow used for implementing the target function and based on a node instance obtained by instantiating; and
executing the first workflow instance to obtain a task handling result of the target task.

In a third aspect, the present disclosure provides a function configuration apparatus, the apparatus includes:
a data obtaining module, configured to obtain a configuration instruction, in which the configuration instruction is used for instantiating a task node in a target workflow to obtain a target node instance, and the target workflow is used for implementing a target function;
a first processing module, configured to construct a first workflow instance of the target workflow based on the target node instance; and
a second processing module, configured to add the first workflow instance to a tool list, in which the tool list is used for characterizing a workflow instance corresponding to a function of a target agent, the target agent being constructed based on the tool list.

In a fourth aspect, the present disclosure provides a task handling apparatus, the apparatus includes:
a function obtaining module, configured to obtain a target function corresponding to a target task;
an instance determining module, configured to determine a first workflow instance in a tool list based on the target function, in which the tool list is used for characterizing a workflow instance corresponding to a function of a target agent; the first workflow instance is constructed by instantiating a task node in a target workflow used for implementing the target function and based on a node instance obtained by instantiating; and
a task executing module, configured to execute the first workflow instance to obtain a task handling result of the target task.

In a fifth aspect, the present disclosure provides an electronic device, which includes: a memory and a processor, the memory and the processor are in communication connection with each other, the memory having a computer instruction stored therein, the processor executes the computer instruction to perform the function configuration method or the task handling method.

In a sixth aspect, the present disclosure provides a computer-readable storage medium having a computer instruction stored thereon, the computer instruction is used for instructing a computer to perform the function configuration method or the task handling method.

In a seventh aspect, the present disclosure provides a computer program product including a computer instruction, the computer instruction is used for instructing a computer to perform the function configuration method or the task handling method.

### BRIEF DESCRIPTION OF DRAWINGS

In order to more clearly illustrate the technical solutions in the specific implementations of the present disclosure or in the prior art, the following will briefly introduce the drawings required for describing the specific implementations or the prior art. Obviously, the drawings in the following description are some implementations of the present disclosure, and for those of ordinary skill in the art, other drawings may also be obtained according to these drawings without paying any creative effort.

FIG. 1 is a flowchart of a function configuration method according to an embodiment of the present disclosure;

FIG. 2 is a schematic diagram of building a workflow according to an embodiment of the present disclosure;

FIG. 3 is a class diagram of a node instance and a workflow instance according to an embodiment of the present disclosure;

FIG. 4 is a flowchart of a task handling method according to an embodiment of the present disclosure;

FIG. 5 is a flowchart of another task handling method according to an embodiment of the present disclosure;

FIG. 6 is a structural block diagram of a function configuration apparatus according to an embodiment of the present disclosure;

FIG. 7 is a structural block diagram of a task handling apparatus according to an embodiment of the present disclosure; and

FIG. 8 is a structural block diagram of an electronic device according to an embodiment of the present disclosure.

### DETAILED DESCRIPTION

To make the objectives, technical solutions, and advantages of the embodiments of the present disclosure clearer, the technical solutions in the embodiments of the present disclosure will be described clearly and completely below with reference to the drawings in the embodiments of the present disclosure. Obviously, the described embodiments are part of the embodiments of the present disclosure, but not all of them. Based on the embodiments in the present disclosure, all other embodiments obtained by those skilled in the art without paying any creative effort shall fall within the protection scope of the present disclosure.

It can be understood that, before using the technical solutions disclosed in the embodiments of the present disclosure, users should be informed of the type, use scope, use scenario, etc. of the personal information involved in the present disclosure and the authorization of the users should be obtained through appropriate means according to relevant laws and regulations.

For example, when a user's active request is received, prompt information is sent to the user, to explicitly prompt the user that the operation requested to be performed will require the acquisition and use of the user's personal information. Therefore, the user can independently select whether to provide personal information to software or hardware such as an electronic device, an application, a server, or a storage medium that performs the operation of the technical solution of the present disclosure according to the prompt information.

As an optional but non-limiting implementation, the manner of sending the prompt information to the user in response to receiving the user's active request may be, for example, a pop-up window, and the prompt information may be presented in the form of text in the pop-up window. In addition, the pop-up window may also provide a selection control for the user to select “agree” or “disagree” to provide personal information to the electronic device.

It may be understood that the above process of notifying and obtaining the user's authorization is only illustrative and does not constitute a limitation to the implementations of the present disclosure, and other manners that satisfy relevant laws and regulations may also be applied to the implementations of the present disclosure.

It can be understood that the data involved in the technical solutions (including but not limited to the data itself, the acquisition or use of the data) should comply with the requirements of corresponding laws, regulations, and relevant provisions.

An agent refers to an intelligent agent that can perceive the environment and take actions to achieve a goal. An agent based on a large language model (abbreviated as LLM) can use tools to interact with the outside world. In related technologies, a large number of preset tools are provided for the agent to implement different functions, for example, network search, scientific computing, or drawing pictures, thereby endowing and enhancing the agent's ability to connect to the outside world. However, each of the tools can only implement a specific function, and when a new function is to be implemented, a tool must be modified or a new tool must be built, resulting in complex expansion of the functions of the agent.

In view of this, according to the embodiments of the present disclosure, an embodiment of a function configuration method is provided. It should be noted that the steps shown in the flowcharts of the drawings may be executed in, for example, a computer system with a set of computer-executable instructions, and although the logical order is shown in the flowcharts, in some cases, the steps shown or described may be executed in a different order from the order here.

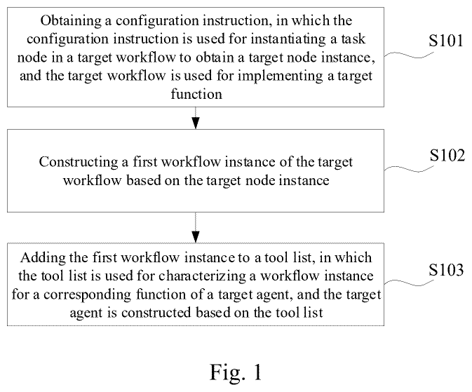

In this embodiment, a function configuration method is provided, which can be used for a configuration platform; the configuration platform is used for building an agent and configuring tools with different functions for the agent. FIG. 1 is a flowchart of a function configuration method according to an embodiment of the present disclosure. As shown in FIG. 1, the process includes the following steps:

Step S101, obtaining a configuration instruction, in which the configuration instruction is used for instantiating a task node in a target workflow to obtain a target node instance, and the target workflow is used for implementing a target function.

It should be noted that the target workflow is a directed acyclic graph (abbreviated as DAG).

Specifically, the language model application development framework provides a runnable interface (also referred to as a Runnable interface), which is used to define an abstract interface of a component or unit that can be run, and can be used to modularize various processing logic so that they can be run in series in a chain. The language model application development framework, as a library, aims to help construct and regulate the chain processing of the language model. Therefore, the runnable interface is one of its core components.

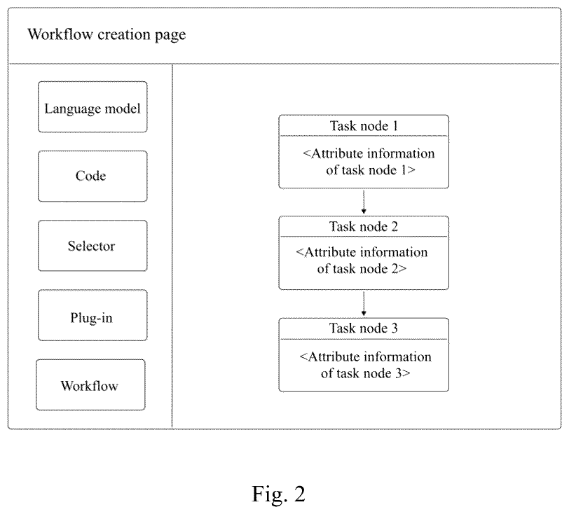

Specifically, in the function configuration method of the present disclosure, for the existing preset tools (also referred to as BaseTool) in the tool list for the target agent, a runnable interface may be provided for the preset tools with different functions, so as to encapsulate the preset tools with different functions into different functional modules. The target workflow for the target function is built by selecting the functional modules. As shown in FIG. 2, the configuration platform displays a workflow creation page, and different functional modules are displayed on the workflow creation page, for example, the functional module corresponding to at least one from a group consisting of a language model, a code, a knowledge base (not shown in the figure), a selector, a plug-in, and a workflow is displayed. In the region where each functional module is located, the description information of the functional module is also displayed. For example, the description information of the language model is “invoke the language model, and use variables and prompts to generate a reply”, the description information of the code is “write code, process input variables to generate a return value”, and the description information of the knowledge base is “in selected knowledge, recall the most matching segment information according to the set number of recall segments and the required similarity setting value, and return it in the form of a list”, the description information of the selector is “connect multiple downstream branches, match the running branch according to the set conditions in the manner of sequential searching, when any preset condition is matched, only run the branch corresponding to the condition, otherwise continue to match the next condition until the end”, and the description information of the workflow is “realize splitting complex tasks or processes according to sub-functions or sub-module capabilities by referring to the workflow type nodes, so as to refine the process and facilitate regulation and maintenance”. The configuration platform builds the target workflow for the target function in response to interactive operations such as selecting operation, dragging operation, and connecting operation for the functional module. As shown in FIG. 2, the task node in the target workflow corresponds to the functional module, and in the region where the task node is located, the attribute information of the task node is also displayed. For example, the attribute information of the task node 1, the attribute information of the task node 2, and the attribute information of the task node 3 are displayed. The attribute information of the task node may be pre-configured, or may be configured by the user according to the actual situation. For example, for the functional module of the code, the user can construct the code to be executed by the task node according to actual needs.

Specifically, the configuration instruction is generated in response to a creation completing instruction of the target workflow; the configuration instruction carries attribute information of each task node in the target workflow. The attribute of the task node is configured through the attribute information to instantiate the task node to obtain the target node instance of the task node.

Step S102, constructing a first workflow instance of the target workflow based on the target node instance.

Specifically, the first workflow instance is constructed by constructing a call list for calling the target node instance.

Step S103, adding the first workflow instance to a tool list, in which the tool list is used for characterizing a workflow instance corresponding to a function of a target agent, and the target agent is constructed based on the tool list.

It is worth noting that the tool list includes workflow instances with different functions, the workflow instances include workflow instances of preset tools and workflow instances built by the preset tools. It should be noted that the preset tool is a base class of the language model application development framework, and a custom workflow instance of the target function may be implemented by inheriting the preset tool.

According to the function configuration method provided in this embodiment, a task node in a target workflow used for implementing a target function is instantiated to obtain a target node instance. Then, a first workflow instance of the target workflow is constructed based on the target node instance. Therefore, the workflow used for implementing the target function can be encapsulated into a workflow tool (that is, the first workflow instance) that can be used by a target agent. Furthermore, the first workflow instance is added to a tool list used for constructing the target agent. Therefore, the target agent can implement the target function through the first workflow instance in the tool list. Compared with the related art, in the present disclosure, the function of an agent can be extended by constructing a workflow without modifying an existing tool or building a new tool, so that the expansion of the function of the agent is simple, and the efficiency of the function configuration of the agent can be effectively improved.

In some optional implementations, the instantiating a task node in a target workflow to obtain a target node instance in the above step S101 includes the following steps.

Step a1, obtaining attribute information of the task node.

Specifically, the attribute information of the task node includes at least one from a group consisting of node identification information, input configuration information, output configuration information, predecessor node information, successor node information, preset parameter information, a node type, and function configuration information corresponding to the node type.

Step a2, performing attribute configuration on the task node based on the attribute information to obtain the target node instance.

Specifically, attribute configuration is performed on the task node based on the attribute information and a pre-configured attribute configuration template. Alternatively, attribute configuration is performed on the task node based on the attribute information and a pre-configured format conversion rule. Alternatively, attribute configuration is performed on the task node in response to an input operation of a related person based on the attribute information.

According to the function configuration method provided in this embodiment, attribute configuration is performed on the task node based on the attribute information to instantiate the task node to obtain the target node instance. Therefore, the execution strategy and running state of the target node instance can be flexibly adjusted through attribute configuration, thereby improving the flexibility and configurability of function configuration.

In some optional implementations, the attribute information includes output configuration information and input configuration information of the task node. Then, the performing attribute configuration on the task node based on the attribute information to obtain the target node instance in the above step a2 includes: configuring the input of the task node based on the input configuration information, and configuring the output of the task node based on the output configuration information to obtain the target node instance.

Specifically, the input configuration information includes an input format and a variable reference definition of input data. The variable reference definition is used to determine the source of the input data, for example, quoting from a predecessor node, or manually specifying, etc. The output configuration information includes an output format and output data. The output data includes runtime parameter information, and the runtime parameter information includes running data reported to a caller when the task node is running, for example, the running data includes at least one from a group consisting of running time, running state, and running result.

According to the function configuration method provided in this embodiment, the input and the output of the task node are configured based on the input configuration information and the output configuration information to obtain the target node instance. Therefore, different functions can be implemented by dynamically adjusting the input configuration information and output configuration information without changing the task processing logic of the task node, thereby improving the flexibility of function configuration.

In some optional implementations, the attribute information further includes predecessor node information of the task node. Then, the performing attribute configuration on the task node based on the attribute information to obtain the target node instance in the above step a2 further includes: configuring an execution condition of the task node based on the predecessor node information to obtain the target node instance, in which the execution condition is used for characterizing that the predecessor node(s) of the task node is (are) completely executed.

Specifically, the predecessor node information includes information about the predecessor node(s) on which the task node depends in the target workflow. Optionally, the predecessor node information includes the number of the predecessor node(s) that is (are) not completely executed.

According to the function configuration method provided in this embodiment, the execution condition of the task node is configured based on the predecessor node information, so that the target node instance is executed only when the predecessor node(s) of the task node is (are) all completely executed. When there is only one predecessor node, the target node instance is executed only when the one predecessor node is completely executed, and when there are a plurality of predecessor nodes, the target node instance is executed only when the plurality of predecessor nodes are all completely executed. Therefore, the correctness of the execution order of each target node instance can be ensured, so as to ensure the correctness of data in the execution process of the target node instance.

In some optional implementations, the attribute information further includes successor node information of the task node. Then, the performing attribute configuration on the task node based on the attribute information to obtain the target node instance in the above step a2 further includes: configuring a next task node triggered after the task node is completely executed based on the successor node information to obtain the target node instance.

Specifically, the successor node information includes a next task node of the task node in the target workflow.

According to the function configuration method provided in this embodiment, the next task node triggered after the task node is completely executed is configured based on the successor node information, so that the target node instance of the next task node is executed only when the current node instance is completely executed. Therefore, the correctness of the dependency relationship between each target node instance can be ensured to improve the accuracy of function configuration.

In some optional implementations, the attribute information further includes a node type of the task node and function configuration information corresponding to the node type. Then, the performing attribute configuration on the task node based on the attribute information to obtain the target node instance in the above step a2 further includes: configuring the type of the task node based on the node type, and configuring the function of the task node based on the function configuration information to obtain the target node instance.

Specifically, the node type includes one from a group consisting of a basic node, a condition node, and a tool node. The basic node has basic node functions such as input and output format definition and input and output variable assignment, for example, may be a start node and an end node. The condition node is used to define the execution condition to determine the running path of the workflow. The tool node is used to bind a workflow instance of a preset tool.

According to the function configuration method provided in this embodiment, the type of the task node is configured based on the node type, and the function of the task node is configured based on the function configuration information to obtain the target node instance. Therefore, the accuracy of function configuration can be further improved.

In some optional implementations, the attribute information further includes preset parameter information. Then, the performing attribute configuration on the task node based on the attribute information to obtain the target node instance in the above step a2 further includes: configuring a preset parameter of the task node based on the preset parameter information to obtain the target node instance.

Specifically, the preset parameter information is parameter information preset by the user in the process of building the target workflow, and the preset parameter information may be represented in a dictionary format. In the running process of the target node instance, the preset parameter information and the runtime parameter information of the target node instance will be reported to the caller together.

In some optional implementations, the node type includes a condition node, and the function configuration information includes a target condition corresponding to the condition node. Then, the configuring the function of the task node based on the function configuration information includes: configuring a condition for executing the task node based on the target condition.

According to the function configuration method provided in this embodiment, when the node type of the task node is the condition node, the condition for executing the task node is configured. Therefore, different conditions can be configured according to different functions and requirements to further improve the flexibility of function configuration.

In some optional implementations, the node type includes a tool node, and the function configuration information includes a second workflow instance in the tool list. Then, the configuring the function of the task node based on the function configuration information includes: configuring a workflow instance called by the task node based on the second workflow instance.

According to the function configuration method provided in this embodiment, when the node type of the task node is the tool node, the workflow instance called by the task node is configured. Therefore, an existing workflow instance can be reused to construct a more complex functional workflow instance to expand the function of the agent.

In some optional implementations, the constructing a first workflow instance of the target workflow based on the target node instance in the above step S102 includes the following steps.

Step b1, constructing a call list for calling the target node instance.

Specifically, determining a node instance representing a start node and a node instance representing an end node in the target node instance to determine a start node and an end node of the first workflow instance. Constructing a node instance list based on other node instances in the target node instance. Constructing the call list based on the start node, the end node, and the node instance list.

Step b2, generating the first workflow instance based on the call list.

Specifically, the call list is used as an attribute of the first workflow instance, and an operation method corresponding to the first workflow instance is configured to obtain the first workflow instance.

According to the function configuration method provided in this embodiment, the call list for calling the target node instance is constructed. Then, the first workflow instance is generated based on the call list. Therefore, it can be ensured that the generated first workflow instance can accurately call each target node instance.

It is worth noting that the task node is a sub-object of workflow management, and the node instance of the task node usually has the following general capabilities: 1. input and output verification; 2. input and output variable assignment; 3. reporting of preset parameters; and 4. reporting of runtime parameters.

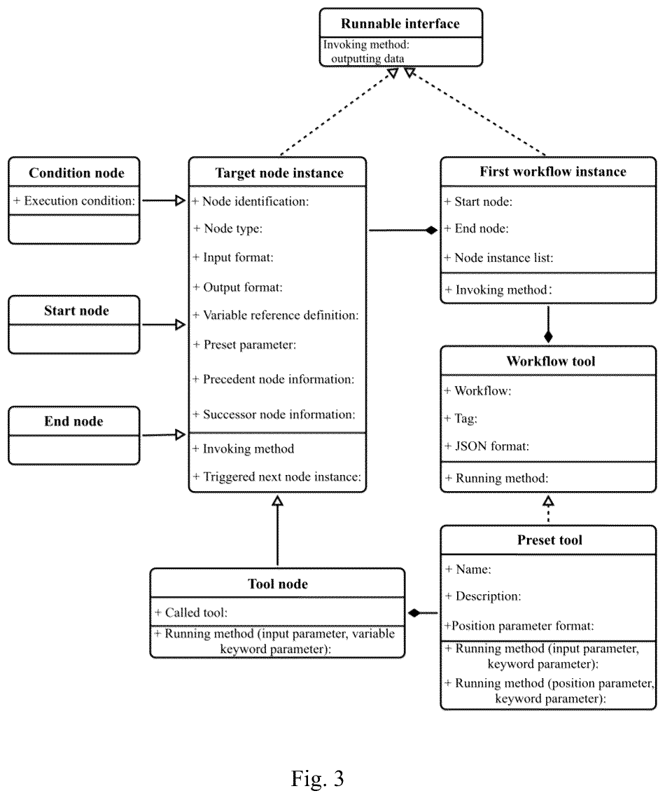

In order to facilitate the understanding of the attribute configuration process of the first workflow instance, the following takes the class diagram shown in FIG. 3 as an example. Among the preset tools in the tool list, attributes such as the name, description, and position parameter format of the preset tools are configured, for example, the name is in a string format, the description is in a string format, and the position parameter format is a selectable type of the preset tool. In this case, the preset tool is also configured with an operation method of the preset tool, for example, a running method (also referred to as a run method) is adopted, the first running method adopts an input parameter and a keyword parameter, and the output format of the first running method is a dictionary format. The second running method adopts a position parameter and a keyword parameter, and the output format of the second running method is any format. A tool node is constructed based on the preset tool. Attributes such as the tool called by the tool node are configured in the tool node, for example, the called tool is a preset tool. In this case, the tool node is also configured with an operation method of the tool node, for example, a running method is adopted, the running method adopts an input parameter and a keyword parameter, and the output format of the running method is a dictionary format. In addition, a condition node is configured. Attributes such as the execution condition are configured in the condition node, for example, the execution condition is a preset condition list. In addition, a start node and an end node may also be configured. Furthermore, the tool node, the condition node, the start node, and the end node are used as subclasses of the node instance of the task node to configure the target node instance. The target node instance is configured with attributes such as a node identification, a node type, an input format, an output format, a variable reference definition, a preset parameter, predecessor node information, and successor node information. For example, the node identification is in a string format, the node type is in a string format, the input format is in a dictionary format, the output format is in a dictionary format, the variable reference definition is in a list format, the preset parameter is in a dictionary format, the predecessor node information is a predecessor node list, and the successor node information is a successor node list. In this case, the target node instance is also configured with an operation method of the target node instance, for example, an invoking method (also referred to as an invoke method) and a triggered next node instance are adopted.

The first workflow instance is generated based on the target node instance, and the first workflow instance is configured with attributes such as a start node, an end node, and a node instance list. At the same time, the first workflow instance is configured with an operation method of the first workflow instance, for example, an invoking method is adopted. Furthermore, a workflow tool is configured based on the first workflow instance, and the workflow tool is configured with attributes such as a workflow, a label, and a JavaScript Object Notation (JSON) format, for example, the workflow is the first workflow instance, the label is an optional label list, and the JSON format is a dictionary format. At the same time, the workflow tool is also configured with an operation method of the workflow tool, for example, a running method is adopted, and the output format of the running method is a dictionary format. In addition, the target node instance and the first workflow instance are also configured with a runnable interface to call the target node instance and the first workflow instance. The runnable interface uses the invoking method to output data.

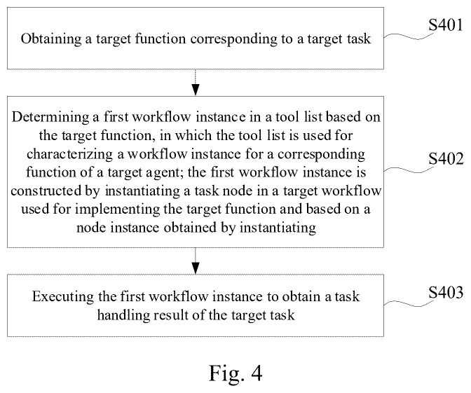

In this embodiment, a task handling method is provided, which can be used for the target agent. FIG. 4 is a flowchart of a task handling method according to an embodiment of the present disclosure. As shown in FIG. 4, the process includes the following steps.

Step S401, obtaining a target function corresponding to a target task.

It should be noted that the target function is a function that the target agent needs to have in the process of handling the target task.

Step S402, determining a first workflow instance in a tool list based on the target function, in which the tool list is used for characterizing a workflow instance corresponding to a function of a target agent; the first workflow instance is constructed by instantiating a task node in a target workflow used for implementing the target function and based on a node instance obtained by instantiating.

It may be understood that the tool list includes workflow instances corresponding to different functions of the target agent, including a workflow instance of a preset tool and a workflow instance of a new function obtained by reusing and expanding the preset tool. In the actual operation process, the first workflow instance may be determined based on the matching of the target function in the tool list. When there is no first workflow instance of the target function in the tool list, the corresponding first workflow instance may be configured by the above function configuration method to execute the target task.

It should be noted that the construction manner of the node instance may refer to the construction manner of the target node instance in the above function configuration method, which will not be repeated here.

Step S403, executing the first workflow instance to obtain a task handling result of the target task.

Specifically, the target task may be executed by invoking the first workflow instance to obtain the task handling result of the target task.

According to the task handling method provided in this embodiment, the target workflow of the target function is built to construct the first workflow instance used for implementing the target function. Then, the first workflow instance is added to the tool list of the target agent. Furthermore, when facing the target task with the target function, the target agent can invoke the first workflow instance in the tool list to implement the processing of the target task to obtain the task handling result. Therefore, for new task requirements, the task may also be completed by constructing a workflow without modifying an existing tool or building a new code, which can effectively improve the ability of the target agent to handle different tasks.

In some optional implementations, the executing the first workflow instance to obtain a task handling result of the target task in the above step S403 includes the following steps.

Step c1, for a node instance in the first workflow instance, obtaining an execution status of a predecessor node of a current node instance.

It should be noted that the node instance representing the start node does not have a predecessor node. Therefore, the node instance representing the start node may be executed directly.

It should be noted that in the initial state, the in-degree of the current node instance is the number of the predecessor node(s), and when the node instance of one predecessor node is completely executed, the in-degree of the current node instance is reduced by one. When it is determined that the in-degree of the current node instance is zero, it represents that all predecessor nodes (or the node instances of the predecessor nodes) are completely executed. When it is determined that the in-degree of the current node instance is not zero, it represents that there is at least one predecessor node that is not completely executed.

Step c2, when the predecessor node is completely executed, executing the current node instance.

It should be noted that when there is at least one predecessor node that is not completely executed, the current node instance is not executed.

Step c3, when the current node instance is completely executed, triggering a next node instance of the current node instance.

It should be noted that the next node instance is a node instance of a successor node corresponding to the current node instance.

Step c4, when the last node instance in the first workflow instance is completely executed, determining an output result of the last node instance as the task handling result.

According to the task handling method provided in this embodiment, the current node instance is executed when all the predecessor nodes are completely executed. In addition, the next node instance of the current node instance is triggered when the current node instance is completely executed. Therefore, the accuracy of the execution order of each node instance can be ensured, thereby improving the accuracy of the final output task handling result.

In some optional implementations, the executing the current node instance when the predecessor node is completely executed in the above step c2 includes:

Step c21, when the predecessor node is completely executed, adding the current node instance to an execution queue.

It should be noted that in the initial state, only the node instance representing the start node is in the execution queue.

It may be understood that there may be multiple parallel branches in the target workflow. Therefore, adding the executable node instance to the execution queue can facilitate the regulation of the computing resource of the executable node instance. In this case, because the queue adopts a first-in first-out processing manner, the sequential execution of each node instance can also be ensured, which is convenient for tracking the node instances that have been processed and avoiding repeated processing.

Step c22, executing the node instance(s) in the execution queue.

Specifically, the node instance(s) in the execution queue is traversed, and the node instance(s) in the execution queue is dynamically updated during the execution process until the node instance representing the end node is executed, and the entire first workflow instance is completely executed.

According to the task handling method provided in this embodiment, when all the predecessor nodes are completely executed, the current node instance is added to the execution queue. Then, the node instance in the execution queue is executed. Therefore, the sequential execution of each node instance can be ensured, and it is convenient to track the node instances that have been processed and avoid repeated processing.

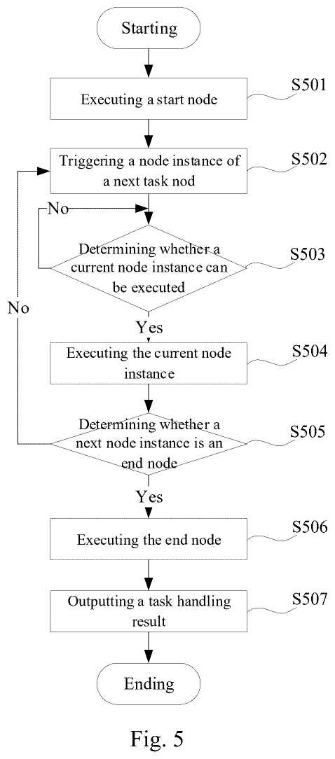

Exemplarily, the task handling method of the present disclosure is described below with a specific example, as shown in FIG. 5, the execution process of the first workflow instance includes the following steps.

Step S501, executing a start node, and after the start node is completely executed, executing Step S502.

Step S502, triggering a node instance of a next task node, and then executing Step S503.

Step S503, determining whether a current node instance can be executed, if yes, executing Step S504, if not, return to Step S503.

Step S504, executing the current node instance, and after the current node instance is completely executed, executing Step S505.

Step S505, determining whether a next node instance is an end node, if yes, executing Step S506, if not, return to Step S502.

Step S506, executing the end node, and after the end node is completely executed, executing Step S507.

Step S507, outputting a task handling result, and ending the execution process.

As a specific application example, a target program is installed on the configuration platform, and the target program is used to execute the function configuration method of the present disclosure. A related person can build the target workflow for implementing the target function through the page displayed by the configuration platform. Then, the configuration platform instantiates the target workflow through the function configuration method of the present disclosure to obtain the first workflow instance, and add the first workflow instance to the tool list of the target agent, so that the target agent can implement the target function through the first workflow instance in the tool list.

It is worth noting that in the present disclosure, the target workflow of the target function is built based on the runnable interface and the preset tool of the language model application development framework. Therefore, the complex task can be decomposed into smaller steps (that is, task nodes) through the target workflow to reduce the complexity of task processing. At the same time, the preset tool can be added to the target workflow as a tool node to construct a more complex tool (that is, the first workflow instance) for the target agent to use without modifying the existing preset tool or building a new code, so that the expansion of the functions of the target agent is simple.

In this embodiment, a function configuration apparatus is further provided, and the apparatus is used to implement the above embodiments and preferred implementations, which will not be repeated here. As used hereinafter, the term “module” may implement a combination of software and/or hardware for a predetermined function. Although the apparatus described in the following embodiments is preferably implemented in software, the implementation in hardware, or the implementation in a combination of software and hardware is also possible and contemplated.

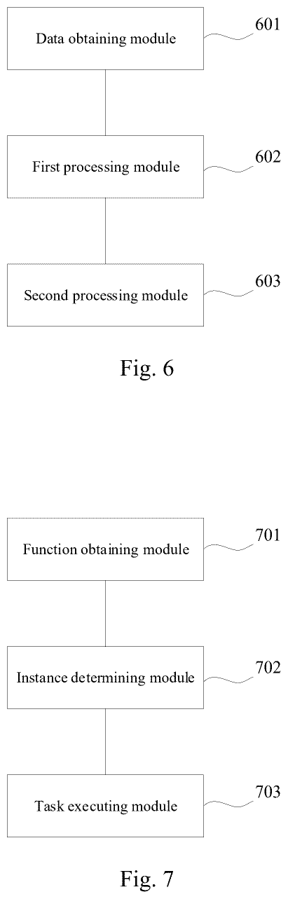

This embodiment provides a function configuration apparatus, as shown in FIG. 6, the apparatus includes:
a data obtaining module 601, configured to obtain a configuration instruction, in which the configuration instruction is used for instantiating a task node in a target workflow to obtain a target node instance, and the target workflow is used for implementing a target function;
a first processing module 602, configured to construct a first workflow instance of the target workflow based on the target node instance; and
a second processing module 603, configured to add the first workflow instance to a tool list, in which the tool list is used for characterizing a workflow instance corresponding to a function of a target agent, and the target agent is constructed based on the tool list.

In some optional implementations, the data obtaining module 601 includes:
an attribute obtaining unit, configured to obtain attribute information of the task node; and
an attribute configuration unit, configured to perform attribute configuration on the task node based on the attribute information to obtain the target node instance.

In some optional implementations, the attribute information includes output configuration information and input configuration information of the task node. Then, the attribute configuration unit includes:
an input-output configuration subunit, configured to configure an input of the task node based on the input configuration information, and configure an output of the task node based on the output configuration information to obtain the target node instance.

In some optional implementations, the attribute information further includes predecessor node information of the task node. Then, the attribute configuration unit includes:
an execution condition configuration subunit, configured to configure an execution condition of the task node based on the predecessor node information to obtain the target node instance, in which the execution condition is used for characterizing that a predecessor node of the task node is completely executed.

In some optional implementations, the attribute information further includes successor node information of the task node. Then, the attribute configuration unit includes:
a successor node configuration subunit, configured to configure a next task node triggered after the task node is completely executed based on the successor node information to obtain the target node instance.

In some optional implementations, the attribute information further includes a node type of the task node and function configuration information corresponding to the node type. Then, the attribute configuration unit includes:
a node function configuration subunit, configured to configure a type of the task node based on the node type, and configure a function of the task node based on the function configuration information to obtain the target node instance.

In some optional implementations, the node type includes a condition node, and the function configuration information includes a target condition corresponding to the condition node. Then, the node function configuration subunit being configured to configure the function of the task node based on the function configuration information includes: the node function configuration subunit being configured to configure a condition for executing the task node based on the target condition.

In some optional implementations, the node type includes a tool node, and the function configuration information includes a second workflow instance in the tool list. Then, the node function configuration subunit being configured to configure the function of the task node based on the function configuration information includes: the node function configuration subunit being configured to configure a workflow instance called by the task node based on the second workflow instance.

In some optional implementations, the first processing module 602 includes:
a list construction unit, configured to construct a call list for calling the target node instance; and
an instance generation unit, configured to generate the first workflow instance based on the call list.

The further functional description of each of the above modules and units is the same as that of the corresponding embodiments above, which will not be repeated here.

The function configuration apparatus in this embodiment is presented in the form of a functional unit, the unit here refers to an application specific integrated circuit (ASIC), a processor and a memory that execute one or more software or fixed programs, and/or other devices that can provide the above functions.

In this embodiment, a task handling apparatus is further provided, and the apparatus is used to implement the above embodiments and preferred implementations of the task handling method, which will not be repeated here. As used hereinafter, the term “module” may implement a combination of software and/or hardware for a predetermined function. Although the apparatus described in the following embodiments is preferably implemented in software, the implementation in hardware, or the implementation in a combination of software and hardware is also possible and contemplated.

This embodiment provides a task handling apparatus, which is applied to a target agent. As shown in FIG. 7, the apparatus includes:
a function obtaining module 701, configured to obtain a target function corresponding to a target task;
an instance determining module 702, configured to determine a first workflow instance in a tool list based on the target function, in which the tool list is used for characterizing a workflow instance corresponding to a function of the target agent, the first workflow instance is constructed by instantiating a task node in a target workflow used for implementing the target function and based on a node instance obtained by instantiating; and
a task executing module 703, configured to execute the first workflow instance to obtain a task handling result of the target task.

In some optional implementations, the task executing module 703 includes:
a first processing unit, configured to, for a node instance in the first workflow instance, obtain an execution status of a predecessor node of a current node instance;
a second processing unit, configured to execute the current node instance when the predecessor node is completely executed;
a third processing unit, configured to trigger a next node instance of the current node instance when the current node instance is completely executed; and
a fourth processing unit, configured to determine an output result of a last node instance in the first workflow instance as the task handling result when the last node instance is completely executed.

In some optional implementations, the second processing unit includes:
a first processing subunit, configured to add the current node instance to an execution queue when the predecessor node is completely executed; and
a second processing subunit, configured to execute the node instance in the execution queue.

The further functional description of each of the above modules and units is the same as that of the corresponding embodiments above, which will not be repeated here.

The function configuration apparatus in this embodiment is presented in the form of a functional unit, the unit here refers to an application specific integrated circuit (ASIC), a processor and a memory that execute one or more software or fixed programs, and/or other devices that can provide the above functions.

The embodiments of the present disclosure further provide an electronic device, which includes the function configuration apparatus shown in FIG. 6 or the task handling apparatus shown in FIG. 7.

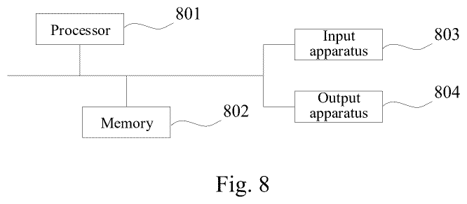

Please refer to FIG. 8, which is a structural block diagram of an electronic device provided in an optional embodiment of the present disclosure. As shown in FIG. 8, the electronic device includes: one or more processors 801, a memory 802, and interfaces for connecting components, the interfaces include a high-speed interface and a low-speed interface. The components communicate with each other through different buses and may be installed on a common motherboard or installed in other manners as required. The processor can process instructions executed within the electronic device, the instructions include instructions stored in the memory or on the memory to display graphical information of the GUI on an external input/output apparatus (such as a display device coupled to an interface). In some optional implementations, if necessary, multiple processors and/or multiple buses may be used with multiple memories. Similarly, multiple electronic devices may be connected, and each device provides part of necessary operations (for example, as a server array, a group of blade servers, or a multi-processor system). FIG. 8 takes one processor 801 as an example.

The processor 801 may be a central processing unit, a network processor, or a combination thereof. The processor 801 may further include a hardware chip. The hardware chip may be an application specific integrated circuit, a programmable logic device, or a combination thereof. The programmable logic device may be a complex programmable logic device, a field programmable logic gate array, a generic array logic, or any combination thereof.

The memory 802 stores instructions executable by at least one processor 801 to enable the at least one processor 801 to perform the method shown in the above embodiments.

The memory 802 may include a program storage region and a data storage region, the program storage region may store an operating system and an application required for at least one function; the data storage region may store data created according to the use of the electronic device, etc. In addition, the memory 802 may include a high-speed random-access memory, and may also include a non-transitory memory, such as at least one magnetic disk storage device, a flash memory device, or other non-transitory solid-state storage devices. In some optional implementations, the memory 802 may optionally include a memory provided remotely from the processor 801, and these remote memories may be connected to the electronic device through a network. Examples of the above network include but are not limited to the Internet, an intranet, a local area network, a mobile communication network, and combinations thereof.

The memory 802 may include a volatile memory, such as a random-access memory; the memory may also include a non-volatile memory, such as a flash memory, a hard disk or a solid-state disk; the memory 802 may also include a combination of the above-mentioned types of memories.

The electronic device further includes an input apparatus 803 and an output apparatus 804. The processor 801, the memory 802, the input apparatus 803, and the output apparatus 804 may be connected through a bus or other means, and FIG. 8 shows an example of the connection through a bus.

The input apparatus 803 can receive input digital or character information and generate key signal input related to user settings and function control of the electronic device, may be, for example, a touchscreen, a keypad, a mouse, a trackpad, a touchpad, a pointing stick, one or more mouse buttons, a trackball, a joystick, etc. The output apparatus 804 may include a display device, an auxiliary lighting apparatus (e.g., an LED), a tactile feedback apparatus (e.g., a vibration motor), and the like. The above display device includes but is not limited to a liquid crystal display, a light emitting diode, a display, and a plasma display. In some optional implementations, the display device may be a touchscreen.

The embodiments of the present disclosure further provide a computer-readable storage medium. The method according to the embodiments of the present disclosure may be implemented in hardware or firmware, or may be implemented as the computer code that can be recorded in a storage medium, or the computer code that is originally stored in a remote storage medium or a non-transitory machine-readable storage medium and will be downloaded and stored in a local storage medium through the network, so that the method described herein may be processed by such software stored on a storage medium using a general-purpose computer, a dedicated processor, or programmable or dedicated hardware. The storage medium may be a magnetic disk, an optical disk, a read only memory, a random access memory, a flash memory, a hard disk, a solid-state disk, and the like; further, the storage medium may further include a combination of the above-mentioned types of memories. It may be understood that the computer, the processor, the microprocessor controller, or the programmable hardware includes a storage component that can store or receive software or computer code, and when the software or computer code is accessed and executed by the computer, the processor, or the hardware, the method shown in the above embodiments is implemented.

A part of the present disclosure may be applied as a computer program product, for example, computer program instructions, when the instructions are executed by a computer, the methods and/or technical solutions according to the present disclosure may be called or provided through operations of the computer. Those skilled in the art should understand that the presence of the computer program instructions in the computer-readable medium includes, but is not limited to, source files, executable files, installation package files, etc. Correspondingly, the manner in which the computer program instructions are executed by the computer includes, but is not limited to, the computer directly executing the instructions, or the computer compiling the instructions and then executing the corresponding compiled program, or the computer reading and executing the instructions, or the computer reading and installing the instructions and then executing the corresponding post-installation program. Here, the computer-readable medium may be any available computer-readable storage medium or communication medium accessible by the computer.

Although the embodiments of the present disclosure have been described in conjunction with the drawings, those skilled in the art can make various modifications and variations without departing from the spirit and scope of the present disclosure, and such modifications and variations all fall within the scope defined by the appended claims.

1. A function configuration method, comprising:
obtaining a configuration instruction, wherein the configuration instruction is used for instantiating a task node in a target workflow to obtain a target node instance, and the target workflow is used for implementing a target function;
constructing a first workflow instance of the target workflow based on the target node instance; and
adding the first workflow instance to a tool list, wherein the tool list is used for characterizing a workflow instance corresponding to a function of a target agent, and the target agent is constructed based on the tool list.

2. The function configuration method according to claim 1, wherein the instantiating a task node in a target workflow to obtain a target node instance comprises:
obtaining attribute information of the task node; and
performing attribute configuration on the task node based on the attribute information to obtain the target node instance.

3. The function configuration method according to claim 2, wherein the attribute information comprises output configuration information and input configuration information of the task node; the performing attribute configuration on the task node based on the attribute information to obtain the target node instance comprises:
configuring an input of the task node based on the input configuration information, and configuring an output of the task node based on the output configuration information to obtain the target node instance.

4. The function configuration method according to claim 2, wherein the attribute information further comprises predecessor node information of the task node; the performing attribute configuration on the task node based on the attribute information to obtain the target node instance further comprises:
configuring an execution condition of the task node based on the predecessor node information to obtain the target node instance, wherein the execution condition is used for characterizing that a predecessor node of the task node is completely executed.

5. The function configuration method according to claim 2, wherein the attribute information further comprises successor node information of the task node; the performing attribute configuration on the task node based on the attribute information to obtain the target node instance further comprises:
configuring a next task node triggered after the task node is completely executed based on the successor node information to obtain the target node instance.

6. The function configuration method according to claim 2, wherein the attribute information further comprises a node type of the task node and function configuration information corresponding to the node type;
the performing attribute configuration on the task node based on the attribute information to obtain the target node instance further comprises:
configuring a type of the task node based on the node type, and configuring a function of the task node based on the function configuration information to obtain the target node instance.

7. The function configuration method according to claim 6, wherein the node type comprises a condition node, and the function configuration information comprises a target condition corresponding to the condition node, the configuring a function of the task node based on the function configuration information comprises:
configuring a condition for executing the task node based on the target condition.

8. The function configuration method according to claim 6, wherein the node type comprises a tool node, and the function configuration information comprises a second workflow instance in the tool list, the configuring a function of the task node based on the function configuration information comprises:
configuring a workflow instance called by the task node based on the second workflow instance.

9. The function configuration method according to claim 1, wherein the constructing a first workflow instance of the target workflow based on the target node instance comprises:
constructing a call list for calling the target node instance; and
generating the first workflow instance based on the call list.

10. A task handling method, comprising:
obtaining a target function corresponding to a target task;
determining a first workflow instance in a tool list based on the target function, wherein the tool list is used for characterizing a workflow instance corresponding to a function of a target agent; the first workflow instance is constructed by instantiating a task node in a target workflow used for implementing the target function and based on a node instance obtained by instantiating; and
executing the first workflow instance to obtain a task handling result of the target task.

11. The task handling method according to claim 10, wherein the executing the first workflow instance to obtain a task handling result of the target task comprises:
for a node instance in the first workflow instance, obtaining an execution status of a predecessor node of a current node instance;
executing the current node instance when the predecessor node is completely executed;
triggering a next node instance of the current node instance when the current node instance is completely executed; and
determining an output result of a last node instance in the first workflow instance as the task handling result when the last node instance is completely executed.

12. The task handling method according to claim 11, wherein the executing the current node instance when the predecessor node is completely executed comprises:
adding the current node instance to an execution queue when the predecessor node is completely executed; and
executing the node instance in the execution queue.

13. An electronic device, comprising:
a memory and a processor, wherein the memory and the processor are in communication connection with each other, the memory stores a computer instruction therein, the processor executes the computer instruction to:
obtain a configuration instruction, wherein the configuration instruction is used for instantiating a task node in a target workflow to obtain a target node instance, and the target workflow is used for implementing a target function;
construct a first workflow instance of the target workflow based on the target node instance; and
add the first workflow instance to a tool list, wherein the tool list is used for characterizing a workflow instance corresponding to a function of a target agent, and the target agent is constructed based on the tool list.

14. The electronic device according to claim 13, wherein the processor executes the computer instruction to:
obtain attribute information of the task node; and
perform attribute configuration on the task node based on the attribute information to obtain the target node instance.

15. The electronic device according to claim 14, wherein the attribute information comprises output configuration information and input configuration information of the task node; the processor executes the computer instruction to:
configure an input of the task node based on the input configuration information, and configure an output of the task node based on the output configuration information to obtain the target node instance.

16. The electronic device according to claim 14, wherein the attribute information further comprises predecessor node information of the task node; the processor executes the computer instruction to:
configure an execution condition of the task node based on the predecessor node information to obtain the target node instance, wherein the execution condition is used for characterizing that a predecessor node of the task node is completely executed.

17. The electronic device according to claim 14, wherein the attribute information further comprises successor node information of the task node; the processor executes the computer instruction to:
configure a next task node triggered after the task node is completely executed based on the successor node information to obtain the target node instance.

18. An electronic device, comprising:
a memory and a processor, wherein the memory and the processor are in communication connection with each other, the memory stores a computer instruction therein, the processor executes the computer instruction to perform the task handling method according to claim 10.

19. A non-transitory computer-readable storage medium, storing a computer instruction thereon, wherein the computer instruction is used for instructing a computer to perform the function configuration method according to claim 1.

20. A non-transitory computer-readable storage medium, storing a computer instruction thereon, wherein the computer instruction is used for instructing a computer to perform the task handling method according to claim 10.
